(19) United States
(12) Patent Application Publication
(10) Pub. No.: US 2008/0183984 A1
(43) Pub. Date: Jul. 31, 2008

(54) Memory system with read-modify-write

(76) Inventors: Dale Beucler, Fort Collins, CO (US); Allen Brown, Corvallis, OR (US)

Correspondence Address: Kathy Manke;Avago Technologies Limited, 4380 Ziegler Road, Fort Collins, CO, 80525, US

(21) Appl. No.: 11/700,335

(22) Filed: Jan. 31, 2007

(51) Int. Cl. G06F 12/00

(52) U.S. Cl. 711/155

(57) ABSTRACT

An integrated circuit includes an array of memory cells, addressing circuitry, and timing and control logic. The array of memory cells is configured to store data bits. The addressing circuitry is configured to address multiple locations of memory cells in response to a clock signal. The timing and control logic is responsive to the clock signal and configured to control a read-modify-write operation to read a first group of data bits from a first address location, modify at least one of the bits of the first group, and write the modified first group to the first address location. The read-modify-write operation is performed within one cycle of the clock signal.

### BACKGROUND

Typically, an electronic system includes a number of integrated circuits that communicate with one another to perform system functions. Often, an electronic system includes a host controller and one or more memory systems, such as a random access memory (RAM) system. The host controller and memory system can be in separate integrated circuit chips or combined into one integrated circuit chip, such as an application specific integrated circuit (ASIC).

RAM temporarily stores data in an electronic system. As systems become more complex, data storage needs increase, which increases the cost of the systems. Since, the cost of an integrated circuit is generally related to the area of the integrated circuit, smaller RAM memory cells result in lower cost integrated circuits and lower cost systems.

Typically, a 1-port RAM includes 1-port memory cells and can perform one read operation or one write operation in one clock cycle. A 2-port RAM, also referred to as a dual-port RAM, includes 2-port memory cells and can perform a read operation and a write operation in one clock cycle. The 2-port RAM includes two sets of circuits that access the same set of 2-port memory cells. These two sets of circuits require more area and 2-port memory cells are considerably larger than 1-port memory cells, which increases the cost of a 2-port RAM.

In many applications, a read-modify-write operation is performed via the RAM. This operation includes reading the contents of memory at one address, changing some or all of the bits of the word that was read, and writing the changed word back into the memory at the same address. Typically, it takes two or more clock cycles to complete a read-modify-write operation. In some applications it is advantageous to complete the read-modify-write operation in one clock cycle of a clock signal.

For these and other reasons, there is a need for the present invention.

### SUMMARY

One aspect of the present invention provides an integrated circuit including an array of memory cells, addressing circuitry, and timing and control logic. The array of memory cells is configured to store data bits. The addressing circuitry is configured to address multiple locations of memory cells in response to a clock signal. The timing and control logic is responsive to the clock signal and configured to control a read-modify-write operation to read a first group of data bits from a first address location, modify at least one of the bits of the first group, and write the modified first group to the first address location. The read-modify-write operation is performed within one cycle of the clock signal.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a diagram illustrating one embodiment of an electronic system according to the present invention.

FIG. 2 is a diagram illustrating one embodiment of a memory system.

FIG. 3 is a diagram illustrating one embodiment of a modify circuit.

FIG. 4A is a flowchart diagram illustrating part of the operation of one embodiment of a memory system.

FIG. 4B is a flowchart diagram illustrating another part of the operation of one embodiment of a memory system.

FIG. 5 is a timing diagram illustrating a read-modify-write operation in one embodiment of a memory system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

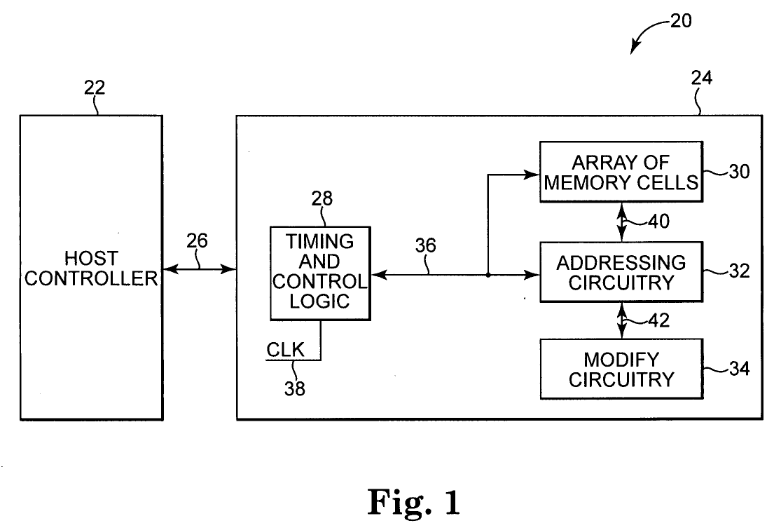

FIG. 1 is a diagram illustrating one embodiment of an electronic system 20 according to the present invention. Electronic system 20 includes a host controller 22 and a memory system 24. Host controller 22 is electrically coupled to memory system 24 via memory communications path 26. Host controller 22 provides control signals to memory system 24 via memory communications path 26 to perform system memory functions. Memory system 24 communicates data to host controller 22 via memory communications path 26. In one embodiment, host controller 22 and memory system 24 communicate all signals, such as control signals, read addresses, write addresses, read data out, write data in, and modify input data, via memory communications path 26. In one embodiment, memory system 24 is a RAM. In one embodiment, memory system 24 is a static RAM (SRAM). In one embodiment, memory system 24 is a pseudo 2-port RAM that includes 1-port memory cells. In one embodiment, host controller 22 is a set of one or more integrated circuit chips and memory system 24 is another set of one or more integrated circuit chips. In one embodiment, host controller 22 and memory system 24 are combined into one ASIC chip.

Memory system 24 includes timing and control logic 28, an array of memory cells 30, addressing circuitry 32, and modify circuitry 34. Timing and control logic 28 is electrically coupled to the array of memory cells 30 and addressing circuitry 32 via timing and control communications path 36. Timing and control logic 28 receives control signals from host controller 22 via memory communications path 26 and a clock signal CLK at 38. In response to the control signals and clock signal CLK at 38, timing and control logic 28 provides timing and control signals to the array of memory cells 30 and addressing circuitry 32 via communications path 36 to provide read, write, read-write, and read-modify-write operations.

In one embodiment, in a read-write operation, timing and control logic 28 controls operation to read a first group of data bits from a first address location and write a second group of data bits to a second address location, where the read-write operation is performed within one cycle of the clock signal. In one embodiment, in a read-modify-write operation, timing and control logic 28 controls operation to read a first group of data bits from a first address location, modify at least one of the bits of the first group, and write the modified first group to the first address location, where the read-modify-write operation is performed within one cycle of the clock signal. In one embodiment, in a read-write operation, timing and control logic 28 controls operation to read a first group of data bits from a first address location, modify at least one of the bits of the first group, and write the modified first group to a second address location, where the read-write operation is performed within one cycle of the clock signal.

Addressing circuitry 32 is electrically coupled to the array of memory cells 30 via array communications path 40 and to modify circuitry 34 via modify communications path 42. Addressing circuitry 32 receives addresses via communications path 36, which are latched in via clock signal CLK at 38. Also, addressing circuitry 32 receives data to modify from the array of memory cells 30 and data to be written into the array of memory cells 30 and provides data read from the array of memory cells 30.

In response to clock signal CLK at 38, addressing circuitry 32 decodes addresses and drives a row line, also referred to as a word line, and columns of the array of memory cells 30 to address locations of memory cells in the array of memory cells 30 via array communications path 40. Addressing circuitry 32 reads data from and/or writes data into the addressed memory cells via array communications path 40.

The array of memory cells 30 stores data bits. In one embodiment, the array of memory cells 30 is an array of 1-port RAM cells. In one embodiment, the array of memory cells 30 is an array of 2-port RAM cells. In other embodiments, the array of memory cells 30 can be any suitable type of memory cells.

Modify circuitry 34 receives data read from the array of memory cells 30 via addressing circuitry 32 and modify communications path 42. Modify circuitry 34 receives modify data and changes or updates the data read from the array of memory cells 30 based on the modify data. Modify circuitry 34 provides the changed or modified data back to addressing circuitry 32 via modify communications path 42. Addressing circuitry 32 writes the modified data into the array of memory cells 30. In one embodiment, modify circuitry 34 provides an error correcting code (ECC) function (e.g., hamming code) that includes ECC decoding and correction of the data read from the array of memory cells 30 and ECC encoding of the modified data prior to returning the modified data to addressing circuitry 32. In one embodiment, modify circuitry 34 provides semaphores in a one cycle atomic operation.

In one embodiment, memory system 24 is one integrated circuit chip that includes timing and control logic 28, the array of memory cells 30, addressing circuitry 32, and modify circuitry 34. In one embodiment, memory system 24 is two integrated circuit chips, where one integrated circuit includes timing and control logic 28, the array of memory cells 30, and addressing circuitry 32 and the other integrated circuit chip includes modify circuitry 34. In other embodiments, memory system 24 can be any suitable number of integrated circuit chips.

In a read operation, timing and control logic 28 receives read control signals, such as a read command and a read address, from host controller 22 via memory communications path 26. In response to the read control signals and clock signal CLK at 38, timing and control logic 28 provides timing and control signals to the array of memory cells 30 and addressing circuitry 32 to perform a read operation.

Addressing circuitry 32 receives the read address that is latched in via clock signal CLK at 38. In response to clock signal CLK at 38, addressing circuitry 32 decodes the read address and drives a row line of the array of memory cells 30 to address locations of memory cells in the array of memory cells 30. Addressing circuitry 32 reads data from the addressed memory cells and provides data read from the array of memory cells 30 to external circuitry, such as host controller 26.

In a write operation, timing and control logic 28 receives write control signals, such as a write command, a write address, and write data, from host controller 22 via memory communications path 26. In response to the write control signals and clock signal CLK at 38, timing and control logic 28 provides timing and control signals to the array of memory cells 30 and addressing circuitry 32 to perform a write operation.

Addressing circuitry 32 receives the write address that is latched in via clock signal CLK at 38 and addressing circuitry 32 receives data to be written into the array of memory cells 30. In response to clock signal CLK at 38, addressing circuitry 32 decodes the write address and drives a row line and columns of the array of memory cells 30 to address locations of memory cells in the array of memory cells 30. Addressing circuitry 32 writes data into the addressed memory cells via array communications path 40.

In a read-write operation, timing and control logic 28 receives read-write control signals, such as a read-write command, a read address, a write address, and write data, from host controller 22 via memory communications path 26. In response to the read-write control signals and clock signal CLK at 38, timing and control logic 28 provides timing and control signals to the array of memory cells 30 and addressing circuitry 32 to perform a read-write operation within one cycle of the clock signal CLK at 38.

Addressing circuitry 32 receives the read address and the write address, which are latched in via clock signal CLK at 38. Also, addressing circuitry 32 receives the write data to be written into the array of memory cells 30. In response to clock signal CLK at 38, addressing circuitry 32 decodes the read address and drives a row line in the array of memory cells 30 to address locations of memory cells in the array of memory cells 30. Addressing circuitry 32 reads data from the addressed memory cells. Also, addressing circuitry 32 decodes the write address and drives a row line and columns of the array of memory cells 30 to address locations of memory cells in the array of memory cells 30. Addressing circuitry 32 writes the write data into the addressed memory cells via array communications path 40.

In another read-write operation, timing and control logic 28 receives read-write control signals, such as a read-write command, a read address, and a write address, from host controller 22 via memory communications path 26. Also, modify circuitry 34 receives modify data from host controller 22 via memory communications path 26. In response to the read-write control signals and clock signal CLK at 38, timing and control logic 28 provides timing and control signals to the array of memory cells 30 and addressing circuitry 32 to perform the read-write operation within one cycle of the clock signal CLK at 38.

Addressing circuitry 32 receives the read address and the write address, which are latched in via clock signal CLK at 38. In response to clock signal CLK at 38, addressing circuitry 32 decodes the read address and drives a row line in the array of memory cells 30 to address locations of memory cells in the array of memory cells 30. Addressing circuitry 32 reads data from the addressed memory cells and passes the data read to modify circuitry 34. Modify circuitry 34 receives the data read and the modify data and changes at least one of the bits of the data read from the array of memory cells 30. The modified data is passed to addressing circuitry 32 via modify communications path 42.

Addressing circuitry 32 decodes the write address and drives a row line and columns of the array of memory cells 30 to address locations of memory cells in the array of memory cells 30. Addressing circuitry 32 writes the modified data into the addressed memory cells via array communications path 40. The read-write operation is performed within one cycle of the clock signal.

In a read-modify-write operation, timing and control logic 28 receives read-modify-write control signals, such as a read-modify-write command, a read address, and a write address, from host controller 22 via memory communications path 26. Also, modify circuitry 34 receives modify data from host controller 22 via memory communications path 26. The read address is the same as the write address. In other embodiments, one address is received and used for both the read address and the write address.

In response to the read-modify-write control signals and clock signal CLK at 38, timing and control logic 28 provides timing and control signals to the array of memory cells 30 and addressing circuitry 32 to perform a read-modify-write operation within one cycle of the clock signal CLK at 38.

Addressing circuitry 32 receives the read address and the write address, which are latched in via clock signal CLK at 38. In response to clock signal CLK at 38, addressing circuitry 32 decodes the read address and drives a row line in the array of memory cells 30 to address locations of memory cells in the array of memory cells 30. Addressing circuitry 32 reads data from the addressed memory cells and passes the data read to modify circuitry 34. Modify circuitry 34 receives the data read and the modify data and changes at least one of the bits of the data read from the array of memory cells 30. The modified data is passed to addressing circuitry 32 via modify communications path 42.

Addressing circuitry 32 decodes the write address and drives the same row line and columns of the array of memory cells 30 to address the same memory cells that were read from in the array of memory cells 30. Addressing circuitry 32 writes the modified data into the addressed memory cells via array communications path 40. The read-modify-write operation is performed within one cycle of the clock signal.

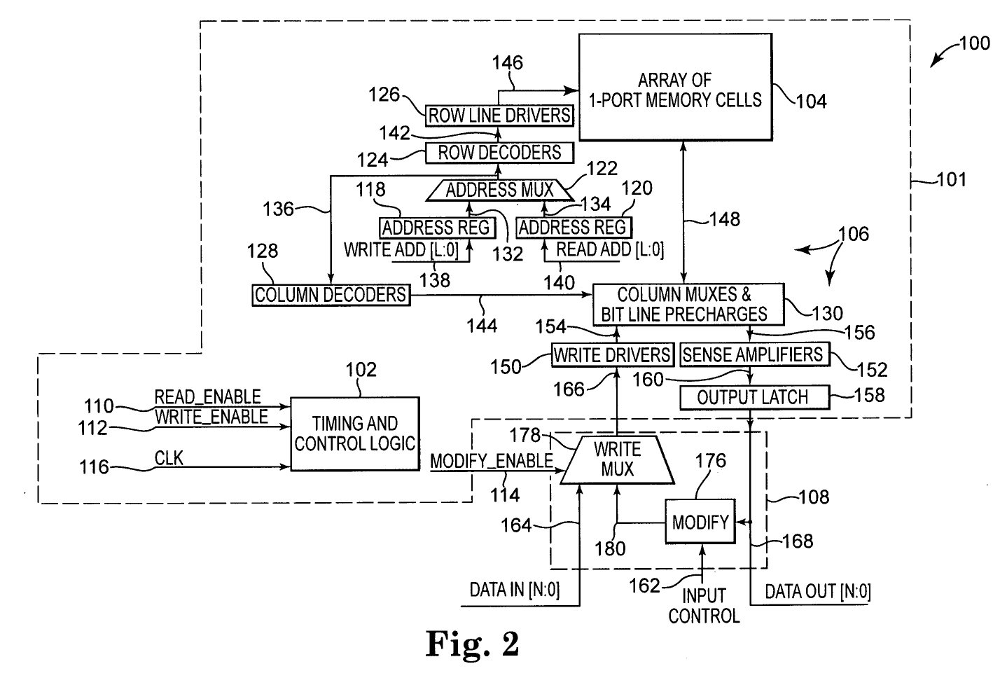

FIG. 2 is a diagram illustrating one embodiment of a memory system 100 that can provide a read-modify-write operation. Memory system 100 includes a memory subsystem 101 and modify circuitry 108. Memory subsystem 101 includes timing and control logic 102, an array of 1-port memory cells 104, and addressing circuitry 106. Memory system 100 is similar to memory system 24 (shown in FIG. 1). In one embodiment, memory system 100 is a pseudo 2-port RAM. In one embodiment, memory subsystem 101 is a pseudo 2-port RAM.

A pseudo 2-port RAM is described and disclosed in U.S. Pat. No. 6,882,562, titled “METHOD AND APPARATUS FOR PROVIDING PSEUDO 2-PORT RAM FUNCTIONALITY USING A 1-PORT MEMORY CELL” and issued to Dale Beucler on Apr. 19^{th}, 2005, which is hereby incorporated by reference.

In one embodiment, memory system 100 is in one integrated circuit chip. In one embodiment, memory system 100 is in one integrated circuit chip that includes memory subsystem 101 in a memory block and modify circuitry 108 outside the memory block. In one embodiment, memory system 100 is in one integrated circuit chip that includes the array of 1-port memory cells 104 and addressing circuitry 106 in a memory block, timing and control logic 102 outside the memory block, and modify circuitry 108 outside the memory block. In one embodiment, memory system 100 is in two integrated circuit chips, where one integrated circuit chip includes memory subsystem 101 and the other integrated circuit chip includes modify circuitry 108. In other embodiments, memory system 100 can be in any suitable number of integrated circuit chips.

Timing and control logic 102 is electrically coupled to the array of 1-port memory cells 104 and addressing circuitry 106 via suitable communications paths (not shown for clarity). Timing and control logic 102 receives a read enable signal READ_ENABLE at 110, a write enable signal WRITE_ENABLE at 112, and a clock signal CLK at 116. In response to clock signal CLK at 116, timing and control logic 102 provides timing and control signals to the array of 1-port memory cells 104 and addressing circuitry 106 to perform read, write, read-write, and read-modify-write operations. Timing and control logic 102 is similar to timing and control logic 28.

Addressing circuitry 106 includes a write address register 118, a read address register 120, an address multiplexer 122, row decoders 124, row line drivers 126, column decoders 128, and column multiplexers and bit line precharges 130. Write address register 118 is electrically coupled to one input of address multiplexer 122 via write address communications path 132 and read address register 120 is electrically coupled to another input of address multiplexer 122 via read address communications path 134. The output of address multiplexer 122 is electrically coupled to row decoders 124 and column decoders 128 via address communications path 136.

Write address register 118, read address register 120, and address multiplexer 122 are electrically coupled to timing and control logic 102. In response to clock signal CLK at 116, timing and control logic 102 controls write address register 118 to latch in write address WRITE ADD [L:0] at 138 and read address register 120 to latch in read address READ ADD [L:0] at 140. Also, timing and control logic 102 controls address multiplexer 122 to direct the write address WRITE ADD [L:0] at 138 and the read address READ ADD [L:0] at 140 to row decoders 124 and column decoders 128.

Row decoders 124 are electrically coupled to row line drivers 126 via row address communications path 142 and column decoders 128 are electrically coupled to column multiplexers and bit line precharges 130 via column address communications path 144. Row line drivers 126 are electrically coupled to rows in the array of 1-port memory cells 104 via row communications path 146. Column multiplexers and bit line precharges 130 are electrically coupled to columns in the array of 1-port memory cells 104 via column communications path 148. Row decoders 124, which select a row, and column multiplexers and bit line precharges 130 act or operate together to select a word to read data from and/or write data into the array of 1-port memory cells 104.

Row line drivers 126 and column multiplexers and bit line precharges 130 are electrically coupled to and controlled by timing and control logic 102. Row line drivers 126 drive addressed rows in the array of 1-port memory cells 104 to read data bits from and write data bits into the array of 1-port memory cells 104. Column multiplexers and bit line precharges 130 select and precharge columns in the array of 1-port memory cells 104 to read data bits from and write data bits into the array of 1-port memory cells 104.

Address circuitry 106 includes write drivers 150, sense amplifiers 152, and an output latch 158. Write drivers 150 are electrically coupled to column multiplexers and bit line precharges 130 via write communications path 154 and sense amplifiers 152 are electrically coupled to column multiplexers and bit line precharges 130 via read communications path 156. Also, output latch 158 is electrically coupled to sense amplifiers 152 via read output communications path 160.

Write drivers 150, sense amplifiers 152, and output latch 158 are electrically coupled to and controlled by timing and control logic 102. Write drivers 150 drive columns in the array of 1-port memory cells 104 to write data bits into the array of 1-port memory cells 104. Sense amplifiers. 152 sense data on columns of the array of 1-port memory cells 104 to read data bits from the array of 1-port memory cells 104. Sense amplifiers 152 provide the data read from the array of 1-port memory cells 104 to output latch 158, which latches in the data.

Modify circuitry 108 is electrically coupled to write drivers 150 via write driver communications path 166. Modify circuitry 108 receives input data DATA IN [N:0] at 164 that is to be written into the array of 1-port memory cells 104. Modify circuitry 108 also receives a modify enable signal MODIFY_ENABLE at 114 and input data signal INPUT CONTROL at 162 to modify data read from the array of 1-port memory cells 104. Output latch 158 receives data sensed or read via sense amplifiers 152. Output latch 158 provides the received data to modify circuitry 108 and in output data DATA OUT [N:0] at 168.

Modify circuitry 108 includes a modify circuit 176 and a write multiplexer 178. Modify circuit 176 is electrically coupled to output latch 158 via output communications path 168 and to one input of write multiplexer 178 via modify output communications path 180.

Modify circuit 176 receives data read from the array of 1-port memory cells via output latch 158 and modify data via input data signal INPUT CONTROL at 162. Modify circuit 176 modifies the received data read from the array of 1-port memory cells based on the modify data. Modify circuitry 176 provides the modified data to write multiplexer 178.

Write multiplexer 178 receives modify enable signal MODIFY_ENABLE at 114 at a select input and write multiplexer 178 is controlled via the modify enable signal MODIFY_ENABLE at 114 to select input data DATA IN [N:0] at 164 or modified data at 180. Write multiplexer 178 provides the selected data to write drivers 150. Addressing circuitry 106 writes the selected data into the array of 1-port memory cells 104.

In one embodiment, modify circuit 176 provides an ECC function including ECC decoding and correction of data read from the array of 1-port memory cells 104, modifying the checked or corrected data based on the modify data, and ECC encoding of the modified data prior to providing the modified data and ECC encoding to write multiplexer 178 and addressing circuitry 106. In one embodiment, modify circuit 176 provides semaphore updates based on the modify data in a one cycle atomic operation.

In one operation, at the start of a clock cycle, such as a rising edge in clock signal CLK at 116, timing and control logic 102 loads read enable signal READ_ENABLE at 110 and write enable signal WRITE_ENABLE at 112. In addition, modify enable signal MODIFY_ENABLE at 114 is provided or loaded to write multiplexer 178. If read enable signal READ_ENABLE at 110 is set and write enable signal WRITE_ENABLE at 112 is cleared, timing and control logic 102 provides timing and control signals to perform a read operation.

In a read operation, read address READ ADD [L:0] at 140 is loaded into read address register 120. The latched read address is provided to row decoders 124 and column decoders 128 via address multiplexer 122. Row decoder 124 decodes the read address to provide a row address and column decoder 128 decodes the read address to address columns in the array of 1-port memory cells 104. Column multiplexer and bit line precharges 130 precharges bit lines for reading and/or writing regardless of the column multiplexer selection.

Next, row line drivers 126 enable a row line in the array of 1-port memory cells 104 and addressed memory cells provide data on the bit lines. The bit lines are coupled to sense amplifiers 152 via column multiplexer and bit line precharges 130. Sense amplifiers 152 are isolated from the bit lines after receiving the data. Next, sense amplifiers 152 are enabled to complete reading the data and the bit lines are precharged via column multiplexer and bit line precharges 130. Sense amplifiers 152 provide read data to output latch 158, which latches in and provides the read data in output data signal DATA OUT [N:0] at 168.

In another operation, at the start of a clock cycle, such as a rising edge in clock signal CLK at 116, timing and control logic 102 loads read enable signal READ_ENABLE at 110 and write enable signal WRITE_ENABLE at 112. In addition, modify enable signal MODIFY_ENABLE at 114 is provided or loaded to write multiplexer 178. If read enable signal READ_ENABLE at 110 is clear and write enable signal WRITE_ENABLE at 112 is set, timing and control logic 102 provides timing and control signals to perform a write operation.

In a write operation, write address WRITE ADD [L:0] at 138 is loaded into write address register 118. Also, write data, which is in input data DATA IN [N:0] at 164, is provided to write drivers 150 via write multiplexer 178. Column multiplexer and bit line precharges 130 precharges bit lines in the array of 1-port memory cells 104.

The latched write address is provided to row decoders 124 and column decoders 128 via address multiplexer 122. Row decoder 124 decodes the write address to provide a row address and column decoder 128 decodes the write address to address columns in the array of 1-port memory cells 104.

Next, row line drivers 126 enable a row line in the array of 1-port memory cells 104. Write drivers 150 drive the write data into the addressed memory cells via column multiplexer and bit line precharges 130. Output latch 158 holds the previous read data and provides the read data in the output data signal DATA OUT [N:0] at 168.

In another operation, at the start of a clock cycle, such as a rising edge in clock signal CLK at 116, timing and control logic 102 loads read enable signal READ_ENABLE at 110 and write enable signal WRITE_ENABLE at 112. In addition, modify enable signal MODIFY_ENABLE at 114 is loaded or provided to write multiplexer 178. If read enable signal READ_ENABLE at 110 is set and write enable signal WRITE_ENABLE at 112 is set, timing and control logic 102 provides timing and control signals to perform a read-write operation. If modify enable signal MODIFY_ENABLE at 114 is cleared, memory system 100 performs a read-write operation.

In a read-write operation, read address READ ADD [L:0] at 140 is loaded into read address register 120 and write address WRITE ADD [L:0] at 138 is loaded into write address register 118. Write data, which is in input data DATA IN [N:0] at 164, is provided to write drivers 150 via write multiplexer 178.

Column multiplexer and bit line precharges 130 precharges bit lines in the array of 1-port memory cells 104. The latched read address is provided to row decoders 124 and column decoders 128 via address multiplexer 122. Row decoder 124 decodes the read address to provide a row address and column decoder 128 decodes the read address to address columns in the array of 1-port memory cells 104.

Next, row line drivers 126 enable a row line in the array of 1-port memory cells 104 and addressed memory cells provide data on the bit lines. The bit lines are coupled to sense amplifiers 152 via column multiplexer and bit line precharges 130.

Sense amplifiers 152 are isolated from the bit lines after receiving the data. Next, sense amplifiers 152 are enabled to complete reading the data and the bit lines are precharged via column multiplexer and bit line precharges 130. Sense amplifiers 152 provide the read data to output latch 158, which latches in and provides the read data in output data signal DATA OUT [N:0] at 168.

The latched write address is provided to row decoders 124 and column decoders 128 via address multiplexer 122. Row decoder 124 decodes the write address to provide a row address and column decoder 128 decodes the write address to address columns in the array of 1-port memory cells 104.

Next, row line drivers 126 enable a row line in the array of 1-port memory cells 104. Write drivers 150 drive the write data into the addressed memory cells via column multiplexer and bit line precharges 130. The read-write operation is executed within one clock cycle of clock signal 116.

In another operation, at the start of a clock cycle, such as a rising edge in clock signal CLK at 116, timing and control logic 102 loads read enable signal READ_ENABLE at 110 and write enable signal WRITE_ENABLE at 112. In addition, modify enable signal MODIFY-ENABLE at 114 is loaded or provided to write multiplexer 178 and different read and write addresses are provided to memory system 100. If read enable signal READ_ENABLE at 110 is set and write enable signal WRITE_ENABLE at 112 is set, timing and control logic 102 provides timing and control signals to perform a read-write operation. If modify enable signal MODIFY_ENABLE at 114 is set, memory system 100 performs a read-write operation including modification of the data read from the array of 1-port memory cells 104 and writing the modified data back into the array of 1-port memory cells 104.

In this read-write operation, read address READ ADD [L:0] at 140 is loaded into read address register 120 and write address WRITE ADD [L:0] at 138 is loaded into write address register 118. Modify data, which is in input data signal INPUT CONTROL at 162, is provided to modify circuit 176. The read address READ ADD [L:0] at 140 and the write address WRITE ADD [L:0] at 138 are different addresses.

Column multiplexer and bit line precharges 130 precharges bit lines in the array of 1-port memory cells 104. The latched read address is provided to row decoders 124 and column decoders 128 via address multiplexer 122. Row decoder 124 decodes the read address to provide a row address and column decoder 128 decodes the read address to address columns in the array of 1-port memory cells 104.

Next, row line drivers 126 enable a row line in the array of 1-port memory cells 104 and addressed memory cells provide data on the bit lines. The bit lines are coupled to sense amplifiers 152 via column multiplexer and bit line precharges 130.

Sense amplifiers 152 are isolated from the bit lines after receiving the data. Next, sense amplifiers 152 are enabled to complete reading the data and the bit lines are precharged via column multiplexer and bit line precharges 130. The latched write address is provided to row decoders 124 and column decoders 128 via address multiplexer 122. Row decoder 124 decodes the write address to provide a row address and column decoder 128 decodes the write address to address columns in the array of 1-port memory cells 104.

Sense amplifier 152 provides the read data to modify circuit 176 via output latch 158, which latches in and provides the read data in output data signal DATA OUT [N:0] at 168. Modify circuit 176 modifies the read data based on the modify data and provides modified data. Write multiplexer 178 receives the modified data and provides the modified data to write drivers 150.

Next, row line drivers 126 enable a row line in the array of 1-port memory cells 104. Write drivers 150 drive the modified data into the addressed memory cells via column multiplexer and bit line precharges 130. The read-modify-write operation is executed within one clock cycle of clock signal 116.

In another operation, at the start of a clock cycle, such as a rising edge in clock signal CLK at 116, timing and control logic 102 loads read enable signal READ_ENABLE at 110 and write enable signal WRITE_ENABLE at 112. In addition, modify enable signal MODIFY_ENABLE at 114 is loaded or provided to write multiplexer 178. If identical read and write addresses are provided to memory system 100 and if read enable signal READ_ENABLE at 110 is set and write enable signal WRITE_ENABLE at 112 is set and modify enable signal MODIFY_ENABLE at 114 is set, timing and control logic 102 provides timing and control signals to perform a read-modify-write operation. Memory system 100 performs the read-modify-write operation including modification of the data read from the array of 1-port memory cells 104 and writing the modified data back into the same address locations read from in the array of 1-port memory cells 104.

In a read-modify-write operation, read address READ ADD [L:0] at 140 is loaded into read address register 120 and write address WRITE ADD [L:0] at 138 is loaded into write address register 118. Modify data, which is in input data signal INPUT CONTROL at 162, is provided to modify circuit 176. The read address READ ADD [L:0] at 140 and the write address WRITE ADD [L:0] at 138 are the same addresses.

Column multiplexer and bit line precharges 130 precharges bit lines in the array of 1-port memory cells 104. The latched read address is provided to row decoders 124 and column decoders 128 via address multiplexer 122. Row decoder 124 decodes the read address to provide a row address and column decoder 128 decodes the read address to address columns in the array of 1-port memory cells 104.

Next, row line drivers 126 enable a row line in the array of 1-port memory cells 104 and addressed memory cells provide data on the bit lines. The bit lines are coupled to sense amplifiers 152 via column multiplexer and bit line precharges 130.

Sense amplifiers 152 are isolated from the bit lines after receiving the data. Next, sense amplifiers 152 are enabled to complete reading the data and the bit lines are precharged via column multiplexer and bit line precharges 130. The latched write address is provided to row decoders 124 and column decoders 128 via address multiplexer 122. Row decoder 124 decodes the write address to provide the same row address and column decoder 128 decodes the write address to address the same columns in the array of 1-port memory cells 104.

Sense amplifier 152 provides the read data to modify circuit 176 via output latch 158, which latches in and provides the read data in output data signal DATA OUT [N:0] at 168. Modify circuit 176 modifies the read data based on the modify data and provides modified data. Write multiplexer 178 receives the modified data and provides the modified data to write drivers 150.

Next, row line drivers 126 enable the row line in the array of 1-port memory cells 104. Write drivers 150 drive the modified data into the addressed memory cells via column multiplexer and bit line precharges 130. The read-modify-write operation is executed within one clock cycle of clock signal 116.

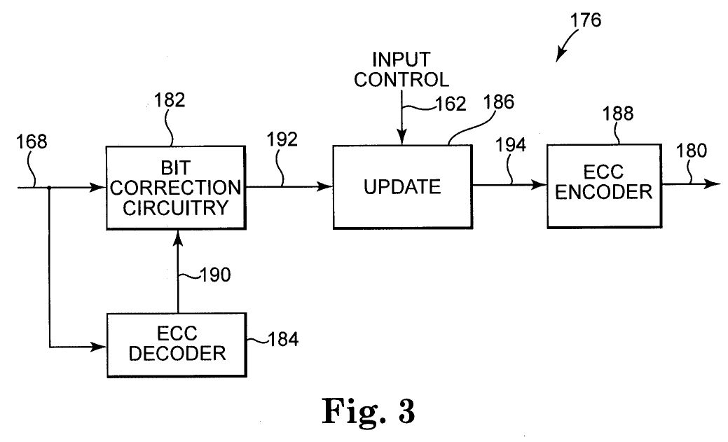

FIG. 3 is a diagram illustrating one embodiment of a modify circuit 176 that includes ECC circuitry. Modify circuit 176 includes bit correction circuitry 182, an ECC decoder 184, update circuitry 186, and an ECC encoder 188. The ECC circuitry includes bit correction circuitry 182, ECC decoder 184, and ECC encoder 188, which can be added to a memory system, such as memory system 100, to improve reliability and yield.

To add ECC to a memory system, the word width is increased, where the additional bits of the word store an ECC encoded form of the original data. In one embodiment, the data read from the array of memory cells, such as the array of 1-port memory cells 104, includes these additional ECC bits and is passed through ECC circuitry to correct up to one bad bit. In other embodiments, the ECC circuitry can correct up to more than one bad bit, such as up to two bad bits.

In modify circuit 176, the checked or corrected data is updated and the updated or modified data is ECC encoded. The modified data and ECC bits are stored back into the memory system. In another embodiment, modify circuit 176 includes update circuitry 186, but not the ECC circuitry, and modify circuit 176 provides a semaphore operation in a single cycle atomic operation.

Bit correction circuitry 182 and ECC decoder 184 receive data read from the array of 1-port memory cells 104, including ECC bits, via output communications path 168. ECC decoder 184 is electrically coupled to bit correction circuitry 182 via decoder communications path 190 and bit correction circuitry 182 is electrically coupled to update circuitry 186 via corrected data communications path 192. ECC decoder 184 decodes the ECC bits and provides correction data to bit correction circuitry 182, which corrects up to one or more bad bits in the data read from the array of 1-port memory cells 104. Bit correction circuitry 182 provides the corrected data to update circuitry 186.

Update circuitry 186 receives modify data in input data signal INPUT CONTROL at 162 and the corrected data via corrected data communications path 192. Update circuitry 186 is electrically coupled to ECC encoder 188 via updated data communications path 194. Update circuitry 186 updates or changes the corrected data based on the modify data and provides modified data to ECC encoder 188 via updated data communications path 194. ECC encoder 188 encodes the modified data and provides the modified data and ECC bits to write multiplexer 178 via modify output communications path 180. The modified data and ECC bits are stored back in the array of 1-port memory cells 104.

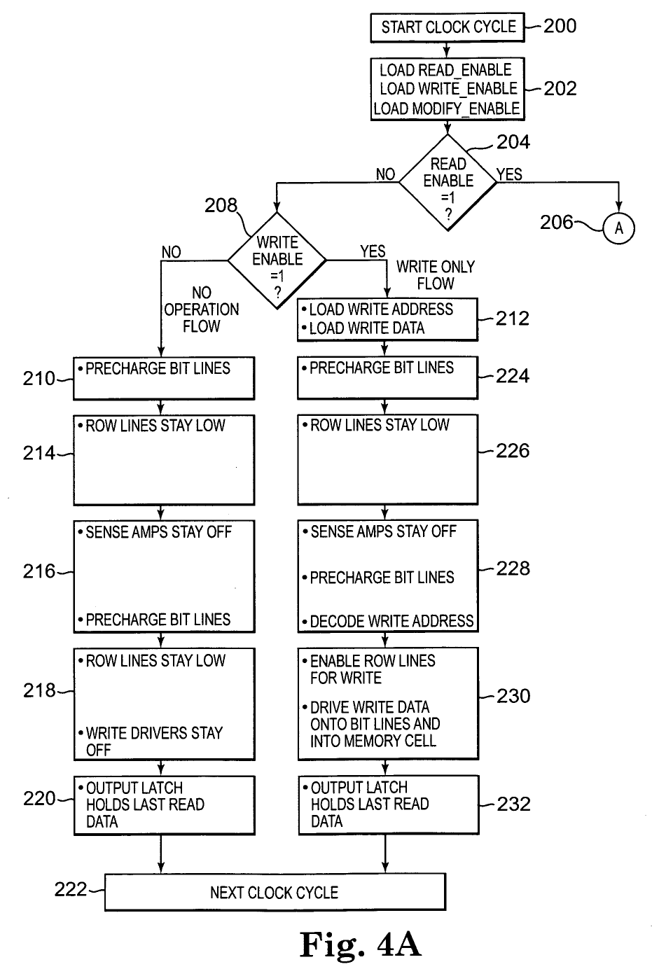

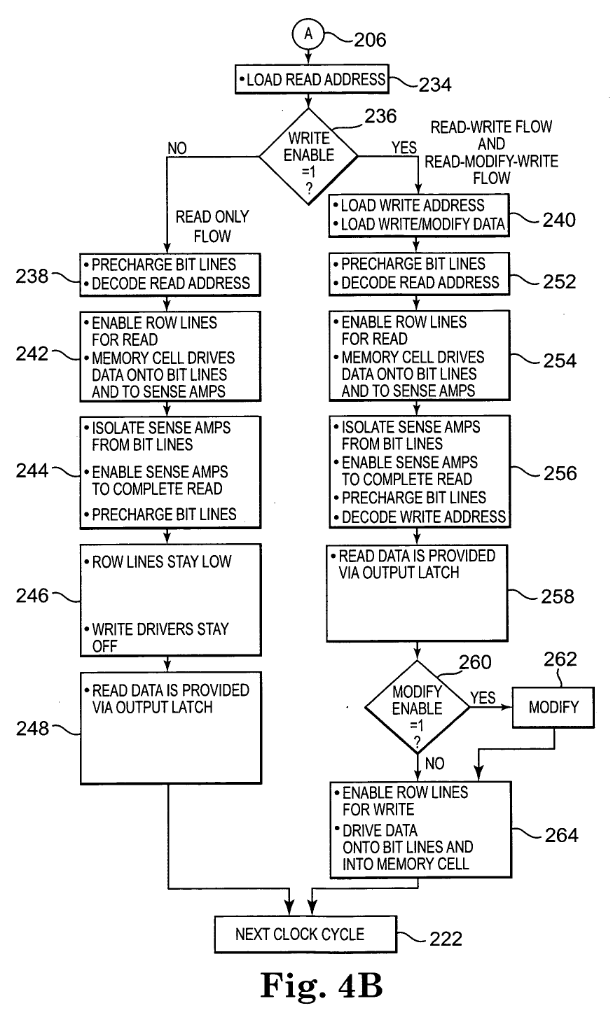

FIGS. 4A and 4B are flowcharts illustrating the operation of one embodiment of a memory system 100 that operates as a pseudo 2-port RAM system. FIG. 4A is a flowchart diagram illustrating a no operation flow and a write only flow. FIG. 4B is a flowchart diagram illustrating a read only flow, a read-write flow, and a read-modify-write flow. Each of the operations is completed within one clock cycle of clock signal CLK at 116.

At the start of a clock cycle 200, such as at a rising edge of clock signal CLK at 116, read enable signal READ_ENABLE at 110, write enable signal WRITE_ENABLE at 112, and modify enable signal MODIFY_ENABLE at 114 are loaded at 202. At 204, if the read enable signal READ_ENABLE at 110 is set, i.e., equal to logic 1, memory system 100 continues at 206 to perform an operation including a read operation. If the read enable signal READ_ENABLE at 110 is clear, i.e., equal to logic 0, memory system 100 continues at 208 to perform an operation that does not include a read operation.

At 208, if the write enable signal WRITE_ENABLE at 112 is clear, memory system 100 continues at 210 to perform a no operation function. In the no operation function, neither a read operation nor a modify operation nor a write operation are performed. If the write enable signal WRITE_ENABLE at 112 is set, memory system 100 continues at 212 to perform a write only operation.

In the no operation flow, neither a read address nor a write address is loaded into memory system 100. Also, neither write data nor modify data is loaded into memory system 100. Bit lines are precharged at 210, but row lines stay inactive low at 214 and sense amplifiers are left inactive or off at 216. Also, bit lines are precharged at 216, but row lines stay inactive or low and write drivers stay off at 218. At 220, output latch 158 holds and provides the previous read data. At 222, processing continues at the next clock cycle, such as at the next rising edge of clock signal CLK at 116.

In the write only flow at 212, write address WRITE ADD [L:0] at 138 is loaded into write address register 118 and write data is provided via data input DATA IN [N:0] at 164. At 224, bit lines are precharged, but row lines stay inactive low at 226 and read sense amplifiers are left inactive or off at 228. Also at 228, bit lines are precharged for the write operation and the loaded write address is decoded. At 230, row lines are enabled via row line drivers 126 and write data is driven into the array of 1-port memory cells 104 via write drivers 150. At 232, output latch 158 holds and provides previously read data. Processing continues at the next clock cycle at 222, such as at the next rising edge of clock signal CLK at 116.

In FIG. 4B, memory system 100 continues at 206 to perform operations including read operations. At 234, read address READ ADD [L:0] at 140 is loaded into read address register 120. At 236, if the write enable signal WRITE_ENABLE at 112 is clear, memory system 100 continues at 238 to perform a read only flow. If the write enable signal WRITE_ENABLE at 112 is set, memory system 100 continues at 240 to perform either a read-write operation or a read-modify-write operation.

In the read only operation at 238, bit lines are precharged and the loaded read address is decoded. At 242, row lines are enabled to read memory cells in the array of 1-port memory cells 104 and the addressed memory cells drive data onto the bit lines and to sense amplifiers 152. At 244, sense amplifiers 152 are isolated from bit lines and enabled to complete the read operation. Also, at 244 the bit lines are precharged, but since a write operation is not enabled, row lines stay low and write drivers stay off at 246. At 248, read data is provided via output latch 158.

If the write enable signal WRITE_ENABLE at 112 is set, memory system 100 continues at 240 to perform either a read-write operation or a read-modify-write operation. At 240, write address WRITE ADD [L:0] at 138 is loaded into write address register 118 and either write data in input data DATA IN [N:0] at 164 or modify data in input data signal INPUT CONTROL at 162 is provided to memory system 100. At 252, bit lines are precharged and the loaded read address is decoded. At 254, row lines are enabled to read memory cells in the array of 1-port memory cells 104 and the addressed memory cells drive data onto the bit lines and to sense amplifiers 152. At 256, sense amplifiers 152 are isolated from bit lines and enabled to complete the read operation. Also, at 256 the bit lines are precharged and the loaded write address is decoded. At 258, output latch 158 provides the read data.

At 260, if the modify enable signal MODIFY_ENABLE at 114 is clear, memory system 100 continues at 264 to perform a read-write operation. If the modify enable signal MODIFY_ENABLE at 114 is set, memory system 100 continues at 262 to perform either a read-write operation including modification of the read data where the read and write addresses are different or a read-modify-write operation including modification of the read data where the read and write addresses are the same.

In the operation at 262, modify circuit 176 receives the data read from the array of 1-port memory cells 104 and modifies the read data based on the modify data. In one embodiment, modify circuit 176 provides ECC correction, modifying, and ECC encoding. In one embodiment, modify circuit 176 provides semaphore updating. In other embodiments, modify circuit 176 provides any suitable modification(s).

Next, at 264 row lines are enabled via row line drivers 126 and the modified data is driven into the array of 1-port memory cells 104 via write drivers 150. Processing continues in the next clock cycle at 222.

In the read-write operation without modification, at 264 row lines are enabled via row line drivers 126 and the write data is driven into the array of 1-port memory cells 104 via write drivers 150. Processing continues in the next clock cycle at 222.

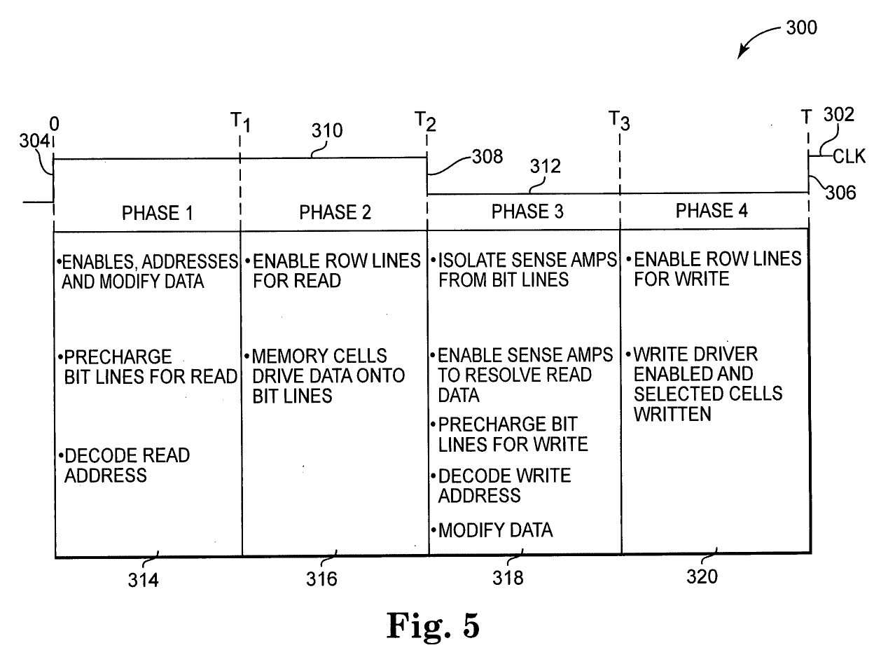

FIG. 5 is a timing diagram 300 illustrating a read-modify-write operation in one embodiment of a memory system 100. The read-modify-write operation includes four phases in one clock cycle of clock signal CLK at 302. Clock signal CLK at 302 includes a period T that begins at rising edge 304 and ends at the next rising edge 306. Clock signal CLK at 302 transitions at 308 from a high voltage level at 310 to a low voltage level at 312. Clock signal CLK at 302 is similar to clock signal CLK at 116.

The operation of memory system 100 is divided into a first phase PHASE 1 at 314, a second phase PHASE 2 at 316, a third phase PHASE 3 at 318, and a fourth phase PHASE 4 at 320, which occur during one period T of clock signal CLK at 302. Each of the four phases PHASE 1 at 314, PHASE 2 at 316, PHASE 3 at 318, and PHASE 4 at 320 includes functions that begin during that phase and may end during that phase or another phase. In one embodiment, each of the four phases PHASE 1 at 314, PHASE 2 at 316, PHASE 3 at 318, and PHASE 4 at 320 is substantially equal in duration to the other four phases. In one embodiment, at least one of the four phases PHASE 1 at 314, PHASE 2 at 316, PHASE 3 at 318, and PHASE 4 at 320 is different in duration from at least one of the other phases.

In PHASE 1 at 314 of the read-modify-write operation, read enable signal READ_ENABLE at 110, write enable signal WRITE_ENABLE at 112, and modify enable signal MODIFY_ENABLE at 114 are loaded substantially at the rising edge 304 of clock signal CLK at 302. Also, in PHASE 1 at 314 read address READ ADD [L:0] at 140 is loaded into read address register 120, write address WRITE ADD [L:0] at 138 is loaded into write address register 118, and modify data is provided in input data signal INPUT CONTROL at 162.

In addition, in PHASE 1 at 314 column multiplexer and bit line precharges 130 precharges bit lines in the array of 1-port memory cells 104. The latched read address is provided to row decoders 124 and column decoders 128 via address multiplexer 122. Row decoder 124 decodes the read address to provide a row address and column decoder 128 decodes the read address to address columns in the array of 1-port memory cells 104.

In PHASE 2 at 316, row line drivers 126 enable a row line in the array of 1-port memory cells 104 and addressed memory cells provide data on the bit lines. The bit lines are coupled to sense amplifiers 152 via column multiplexer and bit line precharges 130.

In PHASE 3 at 318, sense amplifiers 152 are isolated from the bit lines after receiving the data and sense amplifiers 152 are enabled to complete reading the data. Also, bit lines are precharged via column multiplexer and bit line precharges 130 and the latched write address is provided to row decoders 124 and column decoders 128 via address multiplexer 122. Row decoder 124 decodes the write address to provide a row address and column decoder 128 decodes the write address to address columns in the array of 1-port memory cells 104.

Also, in PHASE 3 at 318, sense amplifiers 152 provide the read data to modify circuit 176 and output latch 158, which provides the read data in the output data signal DATA OUT [N:0] at 168. Modify circuit 176 modifies the read data based on the modify data and provides modified data. Write multiplexer 178 receives the modified data and provides the modified data to write drivers 150.

In PHASE 4 at 320, row line drivers 126 enable the row line in the array of 1-port memory cells 104. Write drivers 150 drive the modified data into the addressed memory cells via column multiplexer and bit line precharges 130. The read-modify-write operation is executed within one clock cycle of clock signal 302.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An integrated circuit comprising:
an array of memory cells configured to store data bits;
addressing circuitry configured to address multiple locations of memory cells in response to a clock signal; and
timing and control logic responsive to the clock signal and configured to control a read-modify-write operation to read a first group of data bits from a first address location, modify at least one of the bits of the first group, and write the modified first group to the first address location, wherein the read-modify-write operation is performed within one cycle of the clock signal.

2. The integrated circuit of claim 1, wherein the timing and control logic is configured to control a read-write operation to read the first group of data bits from the first address location and write a second group of data bits to a second address location, wherein the read-write operation is performed within one cycle of the clock signal.

3. The integrated circuit of claim 1, wherein the timing and control logic is configured to control a read operation to read the first group of data bits from the first address location, wherein the read operation is performed within one cycle of the clock signal.

4. The integrated circuit of claim 1, wherein the timing and control logic is configured to control a write operation to write a second group of data bits to a second address location, wherein the write operation is performed within one cycle of the clock signal.

5. The integrated circuit of claim 1, wherein the timing and control logic is configured to divide the one cycle of the clock signal into at least a first phase, a second phase, a third phase, and a fourth phase, wherein a read operation of the read-modify-write operation is at least partially performed during the first phase, a modify operation of the read-modify-write operation is at least partially performed during the third phase, and a write operation of the read-modify-write operation is at least partially performed during the fourth phase.

6. The integrated circuit of claim 1, wherein the timing and control logic is configured to divide the one cycle of the clock signal into at least a first phase, a second phase, a third phase, and a fourth phase, wherein a read operation of the read-modify-write operation is at least partially performed during the first phase, the read operation of the read-modify-write operation is at least partially performed during the second phase, the read operation and a write operation of the read-modify-write operation is at least partially performed during the third phase, a modify operation of the read-modify-write operation is at least partially performed during the third phase, and the write operation of the read-modify-write operation is at least partially performed during the fourth phase.

7. The integrated circuit of claim 1, wherein memory cells in the array of memory cells are 1-port memory cells.

8. The integrated circuit of claim 1, comprising:
modify circuitry configured to modify the first group of data bits read from the array of memory cells.

9. The integrated circuit of claim 1, wherein the integrated circuit is an application specific integrated circuit.

10. A memory system comprising:
an array of 1-port memory cells;
modify circuitry configured to modify data read from the array of 1-port memory cells; and
timing and control logic configured to control an operation in response to a clock signal to read in a first clock-cycle of the clock signal a first group of data bits from a first address location, modify in the first clock cycle at least one of the data bits of the first group via the modify circuitry, and write in the first clock cycle the modified first group to one of the first address location and a second address location.

11. The memory system of claim 10, wherein the timing and control logic is configured to control a read-write operation to read a second group of data bits from a third address location and write a third group of data bits to a fourth address location, wherein the read-write operation is performed within a second clock cycle of the clock signal.

12. The memory system of claim 10, wherein the timing and control logic is configured to control a read operation to read a second group of data bits from a third address location, wherein the read operation is performed within a second clock cycle of the clock signal.

13. The memory system of claim 10, wherein the timing and control logic is configured to control a write operation to write a second group of data bits to a third address location, wherein the write operation is performed within a second clock cycle of the clock signal.

14. The memory system of claim 10, wherein the modify circuitry is configured to perform an error correcting code operation.

15. The memory system of claim 10, wherein the modify circuitry is configured to perform a semaphore operation.

16. A method of operating random access memory, comprising:
reading, in a first clock cycle, a first group of data bits from memory cells in the random access memory;
modifying, in the first clock cycle, the first group of data bits into a second group of data bits; and
writing, in the first clock cycle, the second group of data bits into memory cells in the random access memory.

17. The method of claim 16, wherein:
reading includes at least partially reading during a first phase and a second phase of the first clock cycle;
modifying includes at least partially modifying during a third phase of the first clock cycle; and
writing includes at least partially writing during a fourth phase of the first clock cycle.

18. The method of claim 16, wherein:
reading includes at least partially reading during a first phase, a second phase, and a third phase of the first clock cycle;
modifying includes at least partially modifying during the third phase of the first clock cycle; and
writing includes at least partially writing during the third phase and a fourth phase of the first clock cycle.

19. The method of claim 16, comprising at least one of:
reading, in a second clock cycle, a third group of data bits from memory cells in the random access memory; and
writing, in the second clock cycle, a fourth group of data bits into memory cells in the random access memory.

20. The method of claim 16, wherein modifying comprises at least one of:
performing an error correcting code operation; and
performing a semaphore operation.
